(19) United States
(12) Patent Application Publication
(10) Pub. No.: US 2020/0126715 A1
(43) Pub. Date: Apr. 23, 2020

(54) ELECTROMAGNETIC DEVICE WITH COIL HAVING TAPERED PORTION

(71) Applicant: Fanuc Corporation, Yamanashi (JP)

(72) Inventor: Shouhei Kobayashi, Minamitsuru-gun (JP)

(73) Assignee: Fanuc Corporation, Yamanashi (JP)

(21) Appl. No.: 16/594,226

(22) Filed: Oct. 7, 2019

(30) Foreign Application Priority Data
Oct. 23, 2018 (JP) 2018-199417

(51) Int. Cl. H01F 27/30; H01F 27/24; H01F 27/02

(52) U.S. Cl. CPC H01F 27/306; H01F 27/02; H01F 27/24

(57) ABSTRACT

An electromagnetic device according to an example of the present disclosure includes an outer iron-core, at least three leg iron-cores disposed radially inward of the outer iron-core and adjacent to each other at a radial center, and at least three coils, each of the at least three coils wound around the corresponding one of the at least three leg iron-cores, wherein each of the at least three coils has corresponding one of tapered portions having a winding area decreasing from a position near the outer iron-core on the corresponding one of the at least three leg iron-cores toward the radial center.

### BACKGROUND OF THE INVENTION

### 1. Field of the Invention

The present invention relates to an electromagnetic device, and more particularly to an electromagnetic device with a coil having a tapered portion.

### 2. Description of the Related Art

For example, as described in JP 2018-133492 A, there has been reported a structure of enclosing an iron-core coil with an outer iron-core that enables an electromagnetic device to provide reduction in leakage of a magnetic flux from the iron-core coil to outside the outer iron-core.

In an electromagnetic device with an outer iron-core divided in the related art, the electromagnetic device needs to be increased in outer diameter to prevent a plurality of coils from interfering with one another, and thus there is a problem in that it is difficult to downsize the electromagnetic device.

### SUMMARY OF THE INVENTION

Thus, it is desirable to provide an electromagnetic device capable of providing a reduced installation area and reduced weight.

An electromagnetic device according to an example of the present disclosure includes an outer iron-core, at least three leg iron-cores disposed radially inward of the outer iron-core and adjacent to each other at a radial center, and at least three coils, each of the at least three coils wound around a corresponding one of the at least three leg iron-cores, wherein each of the at least three coils has corresponding one of tapered portions having a winding area decreasing from a position near the outer iron-core on the corresponding one of the at least three leg iron-cores toward the radial center.

### BRIEF DESCRIPTION OF THE DRAWINGS

The present invention will be more clearly understood with reference to the following accompanying drawings:

FIG. 1A is a plan view of an electromagnetic device according to Example 1;

FIG. 1B is a cross-sectional view of the electromagnetic device according to Example 1;

FIG. 2A is a plan view of a typical electromagnetic device;

FIG. 2B is a cross-sectional view of the typical electromagnetic device;

FIG. 3A is a plan view of an electromagnetic device according to Example 2;

FIG. 3B is a cross-sectional view of the electromagnetic device according to Example 2;

FIG. 4 is a perspective view of a coil constituting the electromagnetic device according to Example 2;

FIG. 5 is a perspective view of a coil constituting a typical electromagnetic device;

FIG. 6 is another example of a cross-sectional view of a coil of the electromagnetic device according to Example 2;

FIG. 7A is a plan view of an electromagnetic device according to Example 3;

FIG. 7B is a cross-sectional view of the electromagnetic device according to Example 3;

FIG. 8 is a plan view of an electromagnetic device according to Example 4; and

FIG. 9 is a plan view of an electromagnetic device according to Example 5.

### DETAILED DESCRIPTION

Hereinafter, an electromagnetic device according to the present invention is described with reference to the drawings. However, the technical scope of the invention is not limited to these embodiments and includes the invention described in the scope of claims and elements equivalent thereto.

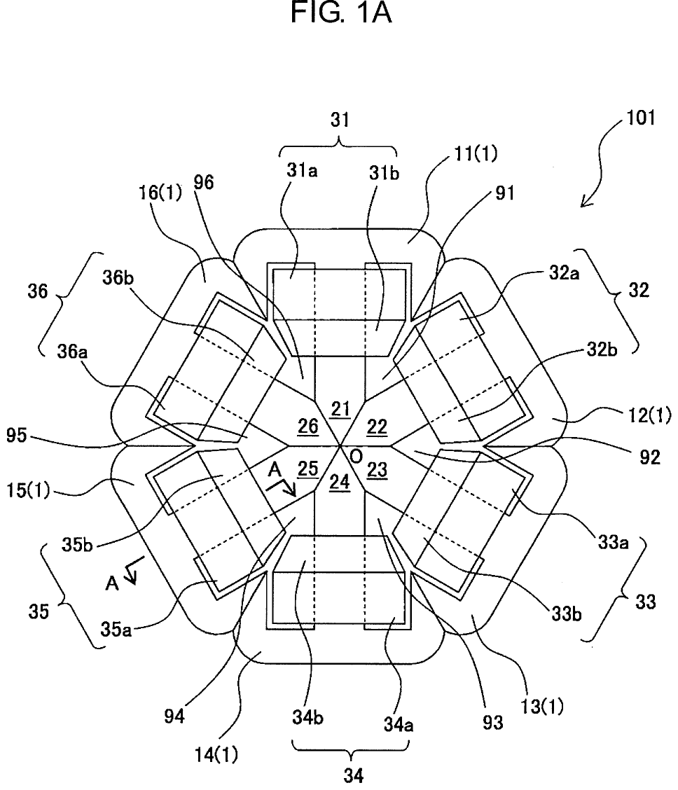

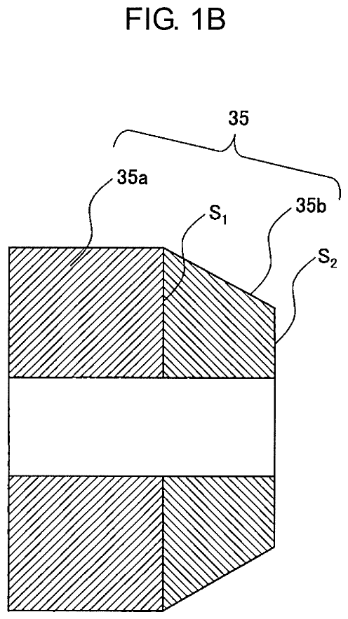

First, an electromagnetic device according to Example 1 of the present disclosure will be described. FIG. 1A illustrates a plan view of the electromagnetic device according to Example 1, and FIG. 1B illustrates a cross-sectional view of the electromagnetic device according to Example 1. An electromagnetic device 101 according to Example 1 includes an outer iron-core 1, at least three leg iron-cores (21 to 26), and at least three coils (31 to 36).

The outer iron-core 1 may include at least three outer iron-core portions (11 to 16). FIG. 1A illustrates an example in which the outer iron-core 1 is divided into six outer iron-core portions (11 to 16). As illustrated in FIG. 1A, the outer iron-core 1 may have an annular structure with a substantially hexagonal shape. However, the present invention is not limited to such an example, and the outer iron-core 1 may have a circular shape or another polygonal shape.

At least three leg iron-cores (21 to 26) are provided radially inward of the outer iron-core 1, and are adjacent to each other at the radial center. FIG. 1A illustrates an example in which six leg iron-cores (21 to 26) are provided. The outer iron-core 1 and the at least three leg iron-cores (21 to 26) may be formed by layering a plurality of steel plates, carbon steel plates, or electromagnetic steel plates, or formed of a pressed powder core.

The at least three leg iron-cores (21 to 26) are substantially identical in size to each other, and are disposed at approximately equal intervals in the circumferential direction of the outer iron-core 1. As illustrated in FIG. 1A, each of the at least three leg iron-cores (21 to 26) has a radially outer end that is in contact with the outer iron-core 1.

In addition, each of the at least three leg iron-cores (21 to 26) has a radially inner end that converges toward the center O of the outer iron-core 1, and has a tip angle of about 60 degrees in the example illustrated in FIG. 1A. The radially inner end of each of the at least three leg iron-cores (21 to 26) may be provided with a magnetically connectible gap.

Each of the at least three coils (31 to 36) are wound around corresponding one of the at least three leg iron-cores (21 to 26). FIG. 1A illustrates an example in which the six coils (31 to 36) are provided. Each of the at least three coils (31 to 36) has corresponding one of tapered portions (31b to 36b) that decreases in winding area from a position near the outer iron-core 1 on the corresponding one of the at least three leg iron-cores (21 to 26) toward the radial center O. Each of the coils (31 to 36) includes a coil body portion (31a to 36a) and a tapered portion (31b to 36b). The coil body portion (31a to 36a) is connected in series with the tapered portion (31b to 36b). The coil body portion (31a to 36a) is wound in the same direction as the tapered portion (31b to 36b).

FIG. 1B illustrates a cross-sectional view of the coil 35 in FIG. 1A taken along line A-A. The coil 35 includes a coil body portion 35a and a tapered portion 35b. Each of the at least three coils (31 to 36) of the electromagnetic device 101 according to Example 1 is characterized by having corresponding one of the tapered portions that decreases in winding area from the position near the outer iron-core 1 on the corresponding one of the at least three leg iron-cores (21 to 26) toward the radial center O. For example, when a winding area of the tapered portion 35b close to the coil body portion 35a is indicated as S₁ and a winding area of the tapered portion 35b close to the center O of the outer iron-core 1 is indicated as S₂, S₂ is less than S₁. As described above, at least three tapered portions (31b to 36b) are disposed in a space formed radially inward of the at least three coil body portions (31a to 36a), so that the electromagnetic device can be reduced in size.

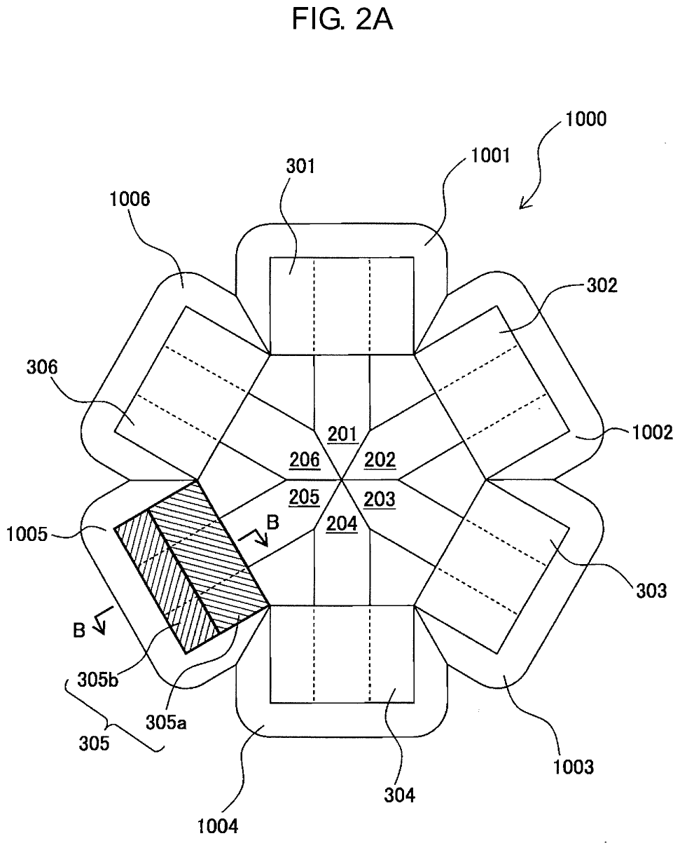

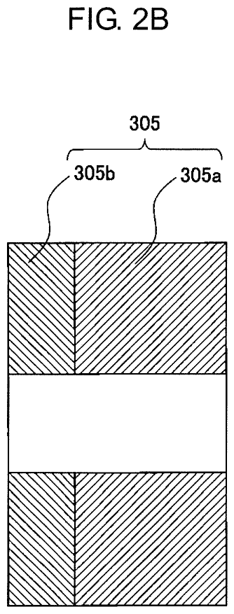

An example of typical electromagnetic devices will be described for comparison with the electromagnetic device according to Example 1. FIG. 2A illustrates a plan view of a typical electromagnetic device, and FIG. 2B illustrates a cross-sectional view of the typical electromagnetic device taken along line B-B of FIG. 2A. Outer iron-core portions (1001 to 1006) disposed annularly constitute an outer iron-core, and coils (301 to 306) are wound around respective six leg iron-cores (201 to 206) disposed on an inner peripheral surface of the outer iron-core. Each of the coils (301 to 306) has no tapered portion.

For example, it is assumed that the number of turns of the coil 305 in FIG. 2A is the same as a total number of turns of the coil body portion 35a and the tapered portion 35b illustrated in FIG. 1A. In this case, on the assumption that the number of turns of a coil body portion 305a on an inner circumferential side of the coil 305 is equal to the number of turns of the coil body portion 35a, and the number of turns of a coil portion 305b on an outer circumferential side of the coil 305 is equal to the number of turns of the tapered portion 35b, it is conceivable that when the coil portion 305b on the outer circumferential side is displaced from the coil 305 to the inner circumferential side of the coil 305, the coil portion 305b on the outer circumferential side corresponds to the tapered portion 35b. Thus, based on the electromagnetic device 101 according to Example 1, a size of an outer periphery of an electromagnetic device 1000 can be reduced to the size of the outer periphery of the electromagnetic device 101. Accordingly, the electromagnetic device 101 according to Example 1 can be reduced more in size than the electromagnetic device 1000 without a coil in a tapered portion.

In addition, the at least three coil body portions (31a to 36a) are preferably wound the same number of times as each other. Furthermore, the at least three tapered portions (31b to 36b) are preferably wound the same number of times as each other. This configuration enables magnetic flux densities generated in each of the at least three leg iron-cores (21 to 26) by the corresponding one of the at least three coil body portions (31a to 36a) and the corresponding one of the at least three tapered portions (31b to 36b) to be equal to each other.

As illustrated in FIG. 1A, each of the tapered portions (31b to 36b) of the at least three coils (31 to 36) may be in contact with the tapered portions of respective adjacent other coils. In addition, cavities (91 to 96) may be formed between the at least three tapered portions (31b to 36b) on a side closer to the center O of the outer iron-core 1 and the at least three leg iron-cores (21 to 26). When the cavities are formed, heat generated by the at least three coil body portions (31a to 36a) and the at least three tapered portions (31b to 36b) can be released to the outside.

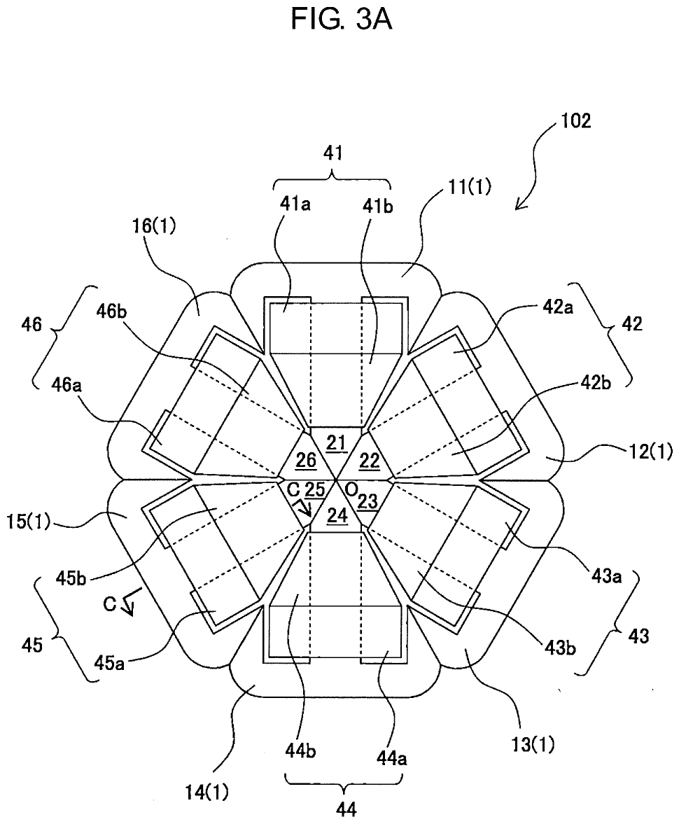

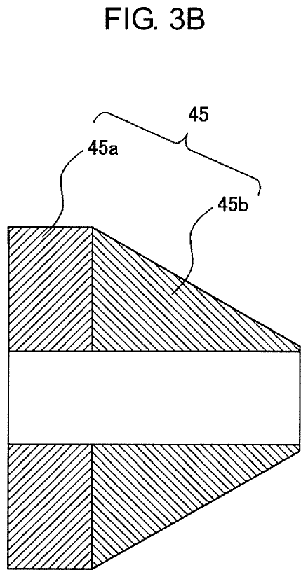

Next, an electromagnetic device according to Example 2 will be described. FIG. 3A illustrates a plan view of the electromagnetic device according to Example 2. An electromagnetic device 102 according to Example 2 is different from the electromagnetic device 101 of Example 1 in that each of the at least three coils (41 to 46) has a shape that fills a space between the outer iron-core 1 and the corresponding one of the at least three leg iron-cores (21 to 26). Other configurations of the electromagnetic device 102 according to Example 2 are similar to those of the electromagnetic device 101 according to Example 1, so that detailed description thereof is eliminated.

Each of the at least three coils (41 to 46) includes a coil body portion (41a to 46a) and a tapered portion (41b to 46b). FIG. 3A illustrates an example in which six coil body portions (41a to 46a) are provided. Each of at least three tapered portions (41b to 46b) is disposed from respective inner peripheral surfaces of the corresponding one of the at least three coil body portions (41a to 46a) toward the center O of the outer iron-core 1. FIG. 3A illustrates an example in which six tapered portions (41b to 46b) are provided. Each of the at least three coil body portions (41a to 46a) is connected in series with the corresponding one of the at least three tapered portions (41b to 46b). In addition, each of the at least three coil body portions (41a to 46a) is wound in the same direction as the corresponding one of the at least three tapered portions (41b to 46b).

FIG. 3B illustrates a cross-sectional view of the coil 45 in FIG. 3A taken along line C-C. The coil 45 includes the coil body portion 45a and the tapered portion 45b. The electromagnetic device 102 according to Example 2 is characterized in that each of the at least three coils (41 to 46) has a shape that fills a space between the outer iron-core 1 and the corresponding one of the at least three leg iron-cores (21 to 26). A configuration as described above enables the at least three tapered portions (41b to 46b) to be more wound in a space formed radially inward of the at least three coil body portions (41a to 46a), so that the electromagnetic device can be further reduced in size.

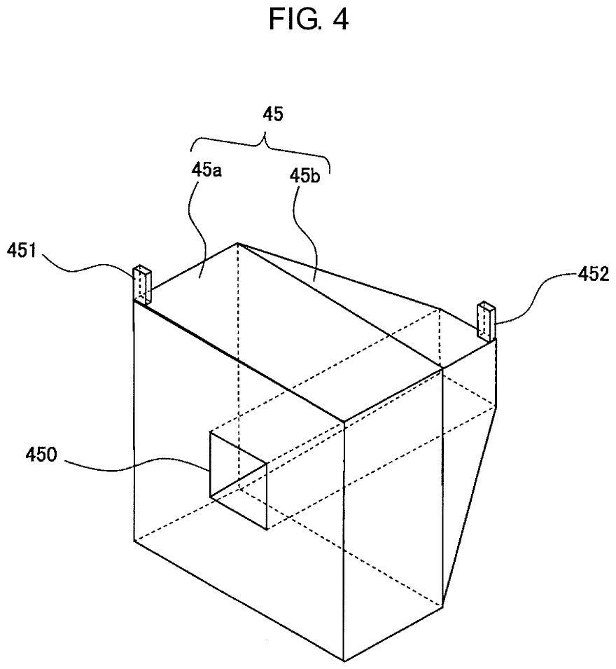

FIG. 4 illustrates a perspective view of the coil 45 constituting the electromagnetic device 102 according to Example 2. The coil 45 includes the coil body portion 45a and the tapered portion 45b with an opening 450 in which the leg iron-core 25 is disposed. As illustrated in FIG. 4, the tapered portion 45b is wound having a shape tapering toward the center of the electromagnetic device 102 to form a tapered leading end. For example, when the electromagnetic device 102 is used as a reactor, an a coil end 451 of the coil body portion 45a may be an input terminal and a coil end 452 of the tapered portion 45b may be an output terminal.

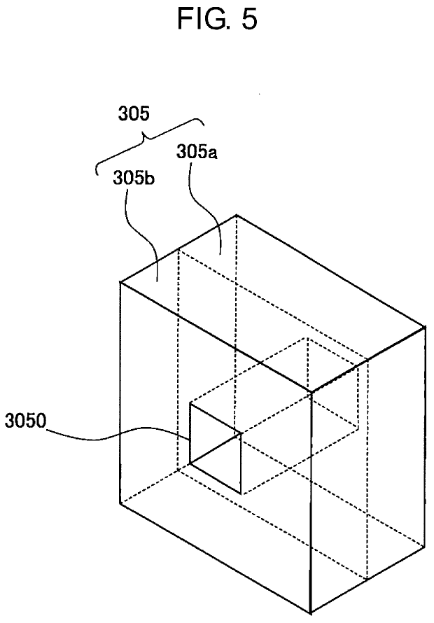

To compare with the electromagnetic device according to Example 2, FIG. 5 illustrates a perspective view of the coil 305 constituting the typical electromagnetic device (refer to FIG. 2A). The coil 305 is provided with an opening 3050 for disposing a leg iron-core 205.

For example, it is assumed that the number of turns of the coil 305 in FIG. 5 is the same as a total number of turns of the coil body portion 45a and the tapered portion 45b illustrated in FIG. 4. In this case, on the assumption that the number of turns of a coil portion 305a on an inner circumferential side of the coil 305 is equal to the number of turns of the coil body portion 45a, and the number of turns of a coil portion 305b on an outer circumferential side of the coil 305 is equal to the number of turns of the tapered portion 45b, it is conceivable that when the coil portion 305b on the outer circumferential side is displaced from the coil 305 to the inner circumferential side of the coil 305, the coil portion 305b on the outer circumferential side corresponds to the tapered portion 45b. Thus, based on the electromagnetic device 102 according to Example 2, the size of the outer periphery of the electromagnetic device 1000 can be reduced to the size of the outer periphery of the electromagnetic device 102. Accordingly, the electromagnetic device 102 according to Example 2 can be reduced more in size than the electromagnetic device 1000 without a tapered coil.

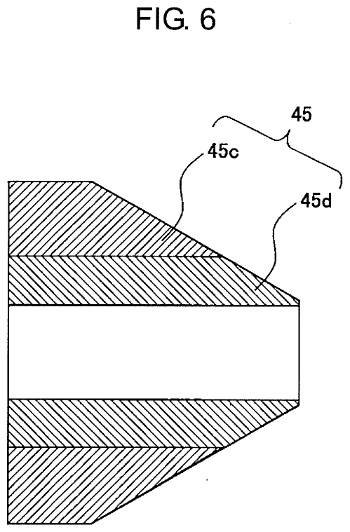

Next, a configuration of a coil for the electromagnetic device 102 according to Example 2 used as a transformer will be described. FIG. 6 illustrates another example of a cross-sectional view of the coil 45 of the electromagnetic device 102 according to Example 2. When the electromagnetic device 102 is used as a transformer, a coil 45c on an outer circumferential side of the coil 45 may serve as a primary coil, and a coil 45d on an inner circumferential side thereof may serve as a secondary coil. With the configuration described above, the electromagnetic device 102 according to Example 2 can be used as a transformer.

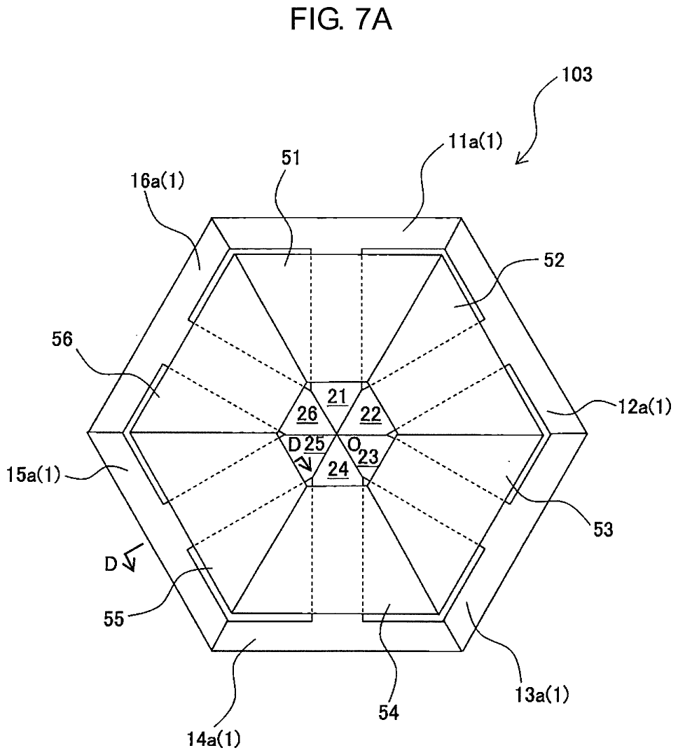

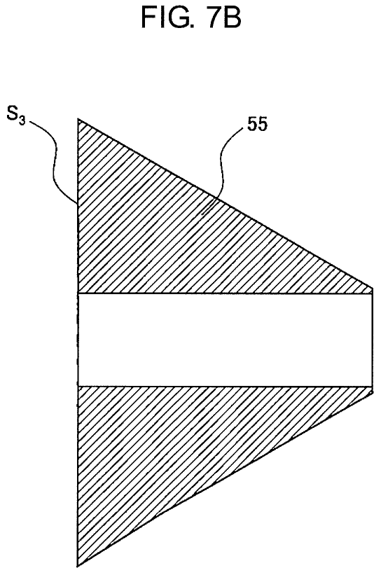

Next, an electromagnetic device according to Example 3 will be described. FIG. 7A illustrates a plan view of the electromagnetic device according to Example 3. An electromagnetic device 103 according to Example 3 is different from the electromagnetic device 101 according to Example 1 in that each of at least three coils (51 to 56) has a tapered shape in which winding area decreases from a position near the outer iron-core 1 on the corresponding one of the at least three leg iron-cores (21 to 26) toward the radial center O. Other configurations of the electromagnetic device 103 according to Example 3 are similar to those of the electromagnetic device 101 according to Example 1, so that detailed description thereof is eliminated.

FIG. 7A illustrates an example in which the six coils (51 to 56) are provided. FIG. 7B illustrates a cross-sectional view of the coil 55 in FIG. 7A taken along line D-D. The electromagnetic device 103 according to Example 3 is characterized in that each of the at least three coils (51 to 56) has a tapered shape in which winding area decreases from the position near the outer iron-core 1 on the corresponding one of the at least three leg iron-cores (21 to 26) toward the radial center O. Accordingly, as illustrated in FIG. 7B, the coil 55 is wound such that winding area in a surface orthogonal to the longitudinal direction of the leg iron-core 25 decreases toward the center O of the outer iron-core. For example, when the winding area of the coil 55 on an outer iron-core 1 side is indicated as S₃, S₃ decreases toward the center O of the outer iron-core. A configuration as described above enables more coils to be wound between the at least three coils (51 to 56) adjacent to each other, so that the electromagnetic device can be further reduced in size.

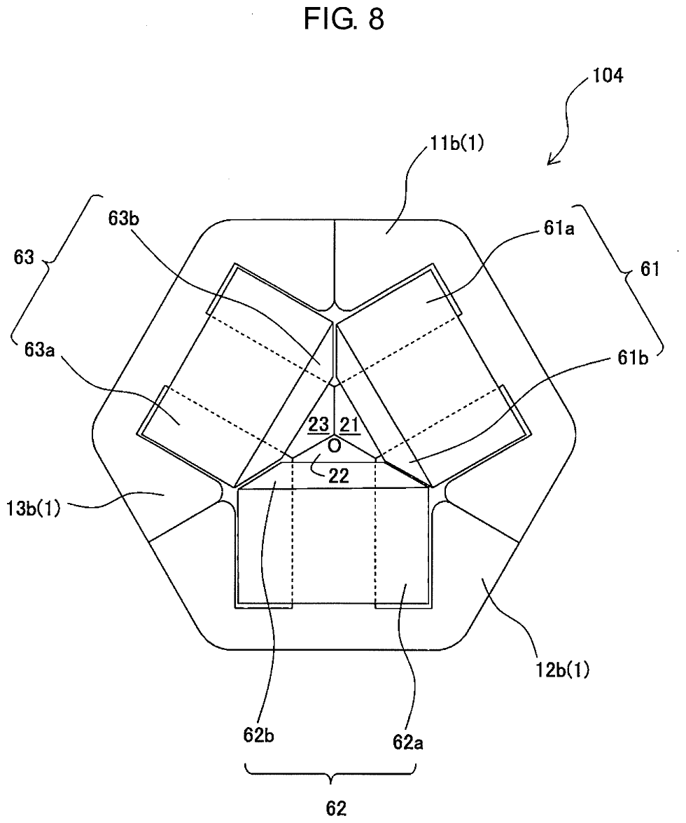

While in the above description, an example is described in which the numbers of outer iron-core portions, leg iron-cores, and coils are each six, the present invention is not limited to this example, and may have a triode structure in which the numbers of outer iron-core portions, leg iron-cores, and coils are each three. FIG. 8 illustrates a plan view of an electromagnetic device according to Example 4. An electromagnetic device 104 according to Example 4 includes an outer iron-core 1, three leg iron-cores (21 to 23), and three coils (61 to 63).

The outer iron-core 1 may be divided into three outer iron-core portions (11b to 13b). As illustrated in FIG. 8, the outer iron-core 1 may have an annular structure with a substantially hexagonal shape. However, the present invention is not limited to such an example, and the outer iron-core 1 may have a circular shape or another polygonal shape.

The three leg iron-cores (21 to 23) are provided radially inward of the outer iron-core 1, and are disposed adjacent to each other at the radial center O.

The three coils (61 to 63) are wound around the corresponding three leg iron-cores (21 to 23). Each of the three coils (61 to 63) has corresponding one of tapered portions (61b to 63b) that decreases in winding area from a position near the outer iron-core 1 on the corresponding one of the three leg iron-cores (21 to 23) toward the radial center O.

As described above, three tapered portions (61b to 63b) are disposed in a space formed radially inward of three coil body portions (61a to 63a), so that the electromagnetic device can be reduced in size.

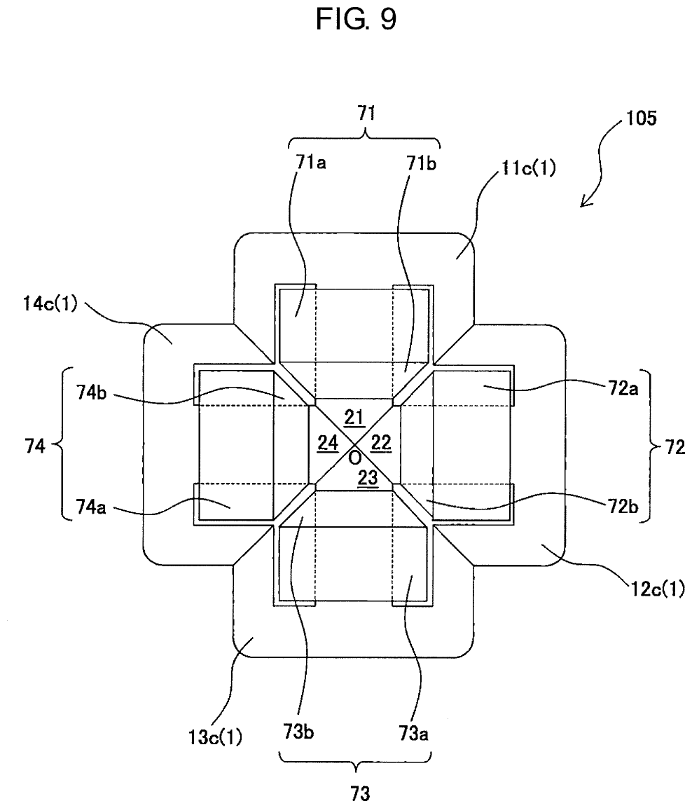

Additionally, a quadrupole structures may be used, in which the numbers of outer iron-core portions, leg iron-cores, and coils are each four. FIG. 9 illustrates a plan view of an electromagnetic device according to Example 5. An electromagnetic device 105 according to Example 5 includes an outer iron-core 1, four leg iron-cores (21 to 24), and four coils (71 to 74).

The outer iron-core 1 may be divided into four outer iron-core portions (11c to 14c). As illustrated in FIG. 9, the outer iron-core 1 may have a cross-shaped structure. However, the present invention is not limited to such an example, and the outer iron-core 1 may have a circular shape or a polygonal shape.

The four leg iron-cores (21 to 24) are provided radially inward of the outer iron-core 1, and are disposed adjacent to each other at the radial center O.

The four coils (71 to 74) are wound around the corresponding four leg iron-cores (21 to 24). Each of the four coils (71 to 74) has corresponding one of tapered portions (71b to 74b) that decreases in winding area from a position near the outer iron-core 1 on the corresponding one of the four leg iron-cores (21 to 24) toward the radial center O.

As described above, four tapered portions (71b to 74b) are disposed in a space formed radially inward of four coil body portions (71a to 74a), so that the electromagnetic device can be reduced in size.

The electromagnetic device according to each of the examples above can be used as a transformer. The electromagnetic device according to each of the present examples can be reduced in size, so that a magnetic path length of each phase of the transformer can be shortened. As a result, magnetic resistance decreases, and thus iron loss can be reduced.

The electromagnetic device according to each of the examples above also can be used as reactor.

The electromagnetic device according to the example of the present disclosure enables an installation area to be reduced and weight to be reduced.

1. An electromagnetic device comprising:
an outer iron-core;
at least three leg iron-cores disposed radially inward of the outer iron-core and adjacent to each other at a radial center; and
at least three coils, each of the at least three coils wound around corresponding one of the at least three leg iron-cores,
wherein each of the at least three coils has one of tapered portions having a winding area decreasing from a position near the outer iron-core on the corresponding one of the at least three leg iron-cores toward the radial center.

2. The electromagnetic device according to claim 1, wherein
each of the tapered portions of the at least three coils is in contact with the tapered portions of respective adjacent other coils.

3. The electromagnetic device according to claim 1, wherein
each of the at least three coils has a shape that fills a space between the outer iron-core and the corresponding one of the at least three leg iron-cores.

4. The electromagnetic device according to claim 1, wherein
the outer iron-core includes at least three outer iron-core portions.

5. The electromagnetic device according to claim 1, wherein
the electromagnetic device is a transformer.

6. The electromagnetic device according to claim 1, wherein
the electromagnetic device is a reactor.
